(19) United States
(12) Patent Application Publication
(10) Pub. No.: US 2026/0091733 A1
(43) Pub. Date: Apr. 2, 2026

(54) FALL PROTECTION FOR A CONSTRUCTION MACHINE

(71) Applicant: JOSEPH VÖGELE AG, Ludwigshafen/Rhein (DE)

(72) Inventor: Nils MEIER, Mannheim (DE)

(73) Assignee: JOSEPH VÖGELE AG, Ludwigshafen/Rhein (DE)

(21) Appl. No.: 19/345,130

(22) Filed: Sep. 30, 2025

(30) Foreign Application Priority Data
Sep. 30, 2024 (EP) 24203449.4

(51) Int. Cl. B60R 3/00

(52) U.S. Cl. CPC B60R 3/005; E01C 2301/40

(57) ABSTRACT

A fall protection device for a construction machine comprises a handrail; an attachment assembly; a plurality of posts arranged at intervals along an X-axis of a Cartesian XYZ coordinate system of the fall protection device and configured to support the handrail and the attachment assembly which are arranged parallel and spaced from one another along a Z-axis of the Cartesian XYZ coordinate system; and a connecting mechanism for connecting the plurality of posts to the handrail and the attachment assembly such that the fall protection device is movable in a plane formed by the X-axis and the Z-axis between a transport position and a working position.

### CROSS-REFERENCE TO RELATED APPLICATIONS

This application claims foreign priority benefits under 35 U.S.C. § 119(a)-(d) to European patent application number 24203449.4, filed September 30, 2024, which is incorporated by reference in its entirety.

### TECHNICAL FIELD

The present disclosure relates to a fall protection device.

### BACKGROUND

Construction machines, in particular road construction machines such as a paving machine, typically have an operator station on which a control panel for controlling the construction machine, at least one driver's seat, and other control devices are located, and on which one or more operators or drivers are present during operation. For a better overview of the construction machine and for monitoring, maintenance, and operation of the construction machine, platforms or catwalks are often provided on one or both sides of the construction machine to facilitate operation of the construction machine.

These catwalks are either stationary at the level of the operator station or are configured to be movable to adjust the height of the catwalk according to the position at which work or inspections are to be carried out.

Since the operator station is typically located at an elevated position on the construction machine or the work must be carried out at elevated positions, a railing is typically attached to the sides of the catwalk as a fall protection device. These also limit access to the catwalk which is usually only possible over a limited area on one side of the construction machine through a cut-out in the railing.

### SUMMARY

Conventional railings used as fall protection devices are, for example, permanently mounted on the construction machine or can be assembled/disassembled as a single unit. Alternatively, they consist of several parts and must be manually unlocked, manually moved from the transport position to the working position, and then locked again. The operator is located, for example, on the catwalk which, depending on the configuration of the construction machine, can be disposed at an elevated position, and also provides only limited space for assembling and disassembling the railing. Due to the bulky individual parts and the restricted movement space, assembly is very time-consuming and entails an increased risk of accidents during assembly and disassembly.

Therefore, it is an object of the present disclosure to provide an improved fall protection device for a construction machine whose handling can be simplified and whose setup time can be shortened.

This object is solved by a fall protection device according to the disclosure. Advantageous further developments according to the disclosure are also provided.

The fall protection device for a construction machine according to the disclosure comprises: a handrail; an attachment assembly; a plurality of posts that is arranged at intervals along an X-axis of a Cartesian XYZ coordinate system of the fall protection device and is configured to support the handrail and the attachment assembly which are arranged parallel and spaced from one another along a Z-axis of the Cartesian XYZ coordinate system; and a connecting mechanism for connecting the plurality of posts to the handrail and the attachment assembly such that the fall protection device is movable between a transport position and a working position in a plane formed by the X-axis and the Z-axis.

The fall protection device described above ensures a quick setup process and reliable assembly and disassembly of the fall protection device.

The movement between the transport position and the operating position can be, for example, a parallelogram guide or a vertical guide.

The handrail can have an open or closed profile with different geometries, such as circular, cuboid, or elliptical. An end cap can be mounted onto each end section of the handrail. The end sections can be formed to be curved. One of the end sections preferably has a length that is sized to extend across the width of the catwalk. A side protection can be attached to this end section to protect the operator from falling down or falling through. The side protection can be U-shaped and have a circular, cuboid, or elliptical tubular shape. Several support elements can be formed on the handrail. The support elements are preferably rod-shaped and extend from the handrail downwardly in the Z-axis direction. In the working position, the support elements preferably serve as stabilizing elements. During the unfolding and folding of the fall protection device, the support elements can serve as guidance aids.

The fall protection device can comprise a knee rail. The knee rail can be arranged parallel to and spaced from the handrail in the vertical direction (Z-axis direction). It can have a tubular shape like the handrail and is typically located centrally between the handrail and the attachment assembly. The distance between the knee rail and the handrail should not exceed 50 cm. More than one knee rail can also be provided.

The attachment assembly can comprise a base plate, a front side wall, a rear side wall, and two lateral side walls connecting the front side wall and the rear side wall to form an upwardly open box shape. The plurality of posts can be arranged to be movable relative to the box shape. In an advantageous embodiment, the attachment assembly can be configured without a rear side wall. The attachment assembly can be arranged to be movable relative to the plurality of posts. The attachment assembly can be a toe board of the fall protection device or of the railing.

The plurality of posts is arranged at regular intervals along the longitudinal direction of the fall protection device to support the handrail and the attachment assembly which are arranged parallel to and spaced from one another in the height direction. The plurality of posts can each be attached to the inner surface of the front side wall and the rear side wall of the attachment assembly. The posts can have a plurality of bores to mount the handrail and the attachment assembly and optionally also the knee rail at different heights according to the specifications.

In a practical embodiment, the fall protection device comprises a handle for manually moving the fall protection device between the transport position and the working position. Due to the formation of a handle, the movement of the fall protection device between the transport position and the working position can be carried out effectively and safely.

In a practical embodiment, the working position can be adjusted by a locking element. It can be prevented in this manner that the fall protection device collapses due to an impact or the operator leaning thereagainst, which could potentially lead to injury. The locking element can be configured such that it allows for only one defined working position. Alternatively, the locking element can be configured to make individually adjustable working positions possible. In particular, the fall protection device can be adjusted to different heights.

In a particularly advantageous variant, the locking element is formed on the attachment assembly. In particular, the locking element is formed on a side disposed opposite the side on which the side protection is provided. The locking element serves to lock the fall protection device in the working position. In a further variant, the locking element can be provided on the same side as the side protection.

Advantageously, the fall protection device further comprises a linear actuator for supporting the movement between the transport position and the working position. The linear actuator can be a gas spring. Since the fall protection devices or railings used on construction machinery are typically produced from metal and can sometimes be formed to be very large, it is advantageous to provide mechanical support for setting up or folding up the fall protection device to further reduce the risk of injury. The linear actuator can be attached to the attachment assembly. The linear actuator can be housed in a recess that is formed in the attachment assembly. This prevents the operator from getting caught on the linear actuator, thereby further reducing the risk of injury. The recess can be formed in the front side wall panel, the rear side wall panel, or therebetween.

In linear actuators or electric cylinders, an electric motor serves as the drive. This is then often a servo motor. The motor can be coupled to a gear, but usually the motor generates the motion directly via a threaded spindle. The spindle can be extended and retracted by way of a left/right rotation. A limitation of the motion can be obtained by the application itself or by a limit switch. The linear actuator generates a pushing and pressing force to move the fall protection device between the transport position A and the working position B. Reaching the transport position A and/or the working position B of the fall protection device can be indicated by outputting a visual or acoustic signal.

Linear actuators have the advantage of being wear-free and requiring hardly any maintenance. Furthermore, they are easy to integrate without affecting the overall size, exhibit high precision in repeatability, and can transmit high forces depending on the specifications of the fall protection device. Furthermore, the linear actuators are self-locking, requiring no additional locking mechanism.

In a practical embodiment, the fall protection device is supported in the transport position by its own weight. In addition, the fall protection device can be locked in the transport position by a locking mechanism. This eliminates the need for additional locking elements, preventing an increase in costs and an increase in the number of components. Furthermore, the setup process is improved. With the box-shaped configuration of the attachment assembly, the plurality of posts can be configured to be movable within the box-shaped attachment assembly such that the transport position is limited by a height of the lateral side wall of the attachment assembly.

Advantageously, the connecting mechanism is a pivot joint at connection points of the plurality of posts so that the motion between the transport position and the working position is a parallelogram guide. The parallelogram guide creates an open degree of freedom that is used for adjustment. In particular, this enables a motion in the XZ plane about the pivot joints. The pivot joint can be formed by a bore that is formed in the post and a bolt inserted into the bore. The connection points are the attachment points of the posts to the handrail and the attachment assembly, if applicable, to the knee rail. A plurality of bores can be formed along the longitudinal direction or the extension direction of the posts. Screws can also be used as a pivot joint. In a practical embodiment, the handle is formed on one of the plurality of posts. The handle can be attached on a side that is disposed opposite the side on which the side protection is formed. The handle can be attached to the side of one of the posts. The operator grasps the handle and moves the fall protection device by pulling it towards the working position and by pushing it towards the transport position. By attaching the handle to the side, the fall protection device can be set up and folded up quickly and in a simple manner.

According to one embodiment, the locking element comprises a latching element that engages with a counterpart formed on one of the plurality of posts. This ensures secure locking of the fall protection device in the working position. The latching element can be a latching pin attached to one of the plurality of posts and the counterpart can be an engagement element in the form of a recess formed in one of the posts. The recess can be formed in a guide element. The guide element can have a conical guide surface configured to guide the latching pin to and into the recess. A return spring can be formed in the latching pin and its return force enables latching and unlatching. The latching and unlatching of the latching pin can be achieved by the operator manually moving the latching pin.

The latching element can be a latching tab attached to the attachment assembly and the counterpart can be a latching element in the form of a recess formed in one of the posts. Alternatively, the latching element can be an intermediate member in the form of a rod-shaped element. In this case, the post is configured as a double post, where the rod-shaped element is arranged between the two posts. The locking element can be configured as a snap lock in which the latching element is configured to be movable such that, when the fall protection device is moved to the working position, the former is moved upwardly by the pressure exerted by the post provided with the recess or the intermediate member of the double post and then latches into the recess or the intermediate member. On the side on which the latching element is formed, the locking element can comprise a return spring, the restoring force of which enables latching and unlatching. The latching and unlatching of the latching element can be achieved by the manual movement of the fall protection device by the operator. Alternatively, a locking/unlocking mechanism can be configured on the locking element to lock it in the working position and release it from this position. Instead of a double post, a single post in the shape of a piece of sheet metal bent to a C shape can alternatively be used. In this case, an opening is formed in the side surface facing the latching tab through which the latching tab engages with the intermediate member. Alternatively, the opening can also form the recess into which the latching tab engages.

According to one embodiment, the fall protection device is supported in the transport position by the own weight of the attachment assembly. In this case as well, no additional locking elements are required, thus preventing an increase in costs and an increase in the number of components. Furthermore, the setup process is improved.

According to a further embodiment, the connecting mechanism is a guide formed on the attachment assembly such that the movement between the transport position and the working position is a vertical guide. The guide can be configured as a tubular element with an optionally round or cuboid cross-section through which the post is led. One or more, preferably two, tubular elements can be used. Alternatively, the guide can be configured as collars that are arranged and attached around the post. In this case as well, one or more, preferably two, collars can be used.

In this embodiment, the handrail can also have an open or closed profile with different geometries, such as circular, cuboid, or elliptical. Using the handrail, the fall protection or railing can be moved quickly and in a simple manner to the working position by pulling it up and automatically locking it. According to this embodiment, it can also be moved just as quickly and in a simple manner to the transport position by pulling the handle.

The handle is advantageously formed on the attachment assembly. By attaching the handle to the attachment assembly, the fall protection device or railing can be pulled to the transport position either by the operator's hand or foot. The handle is preferably attached to a top side of the attachment assembly, in particular to the top side of the rear side wall. The handle can be provided at the center of the attachment assembly. Furthermore, the length of the handle can be sized such that it extends over at least one-third of the length of the attachment assembly. The length of the handle can extend over half or the entire length of the top side of the attachment assembly. Alternatively, the handle can also be formed on the front side surface of the attachment assembly. In this case as well, the length of the handle can extend over one-third or half the length, or over the entire length of the attachment assembly. In a further advantageous variant, two handles can be formed on the top side or the front side surface of the attachment assembly. The number and/or length of the handles can be selected according to the dimensions and weight of the fall protection device.

According to an advantageous embodiment, the handle can be a trapezoidal rod with, for example, a round or oval cross-section. End sections of the trapezoidal rod are, for example, bent outwardly so that they can be attached to a top side of the attachment assembly. The handle can be attached to the front or rear side wall. A plate-shaped attachment member is provided at each end section and can be welded to the handle or connected by way of a frictional fit. Alternatively, the end sections of the trapezoidal rod can be formed to be flat or plate-shaped. The plate-shaped attachment member has, for example, one or a plurality of passage holes. An attachment plate can be attached to the inner surface of the front or rear side wall. The attachment plate is formed to be, for example, L-shaped and is attached to the front or rear side wall such that the short leg of the L-shape is at the height of the top side and protrudes inwardly to serve as a support surface. The long leg of the L-shape can be attached to the inner surface of the front or rear side wall using screws or bolts. The short leg of the L-shape comprises, for example, passage holes that correspond to the number of passage holes in the plate-shaped attachment member. The plate-shaped attachment member is screwed to the attachment plate, for example, using screws. The attachment plate optionally serves as reinforcement to ensure secure attachment of the handle. The legs of the L-shape can be of equal length.

According to one embodiment, the locking element is a screw-shaped element that interacts with the guide to lock the fall protection device in the working position. The screw-shaped element comprises a screw head and a shaft. The shaft of the screw-shaped element can be formed to be threaded or non-threaded. The latching element can be formed on the guide.

If the fall protection device is taken to the working position by pulling it upwardly, then the automatic lock can be achieved by a snap lock in which a latching tab can engage in a recess. By pulling on the handle, the engagement between the latching tab and the recess can be released and the fall protection device can be moved to the transport position.

Furthermore, the attachment assembly can comprise a support that is formed to be U-shaped for receiving the knee rail when the fall protection device is in the transport position.

The fall protection device according to the disclosure can be configured as a module and, depending on the construction machine, two or more fall protection modules can be connected to each other by screw connections.

Each of the previously described embodiments or advantageous further developments ensures a quick setup process and safe assembly and disassembly of the fall protection device, while simultaneously reducing the number of components and saving costs.

In a further aspect, the disclosure relates to a construction machine with a fall protection device in any of the embodiments described. The construction machine can be, in particular, a paving machine or a feeder vehicle for feeding a paving machine.

### BRIEF DESCRIPTION OF THE DRAWINGS

FIG. 1 shows a perspective view of a fall protection device according to a first embodiment of the present disclosure in a transport position;

FIG. 2 shows a perspective view of a fall protection device according to a first embodiment of the present disclosure in a work position;

FIG. 3 shows a partial view of FIG. 2 illustrating a locking element on an attachment assembly according to one embodiment and shows a section D along a cross section A-A illustrating a locking element on one of the posts according to a further embodiment;

FIG. 4 shows an enlarged view of section D of FIG. 3;

FIG. 5 shows a perspective view of a fall protection device according to a second embodiment of the present disclosure in a transport position;

FIG. 6 shows a perspective view of a fall protection device according to a second embodiment of the present disclosure in a work position;

FIG. 7 shows a detailed view of a connecting mechanism and a locking element according to the second embodiment of the present disclosure; and

FIG. 8 shows a construction machine with a fall protection device mounted on a catwalk.

### DETAILED DESCRIPTION

Embodiments of the present disclosure shall be described in more detail below with reference to the figures. In the description and the drawings, the same or corresponding components are denoted by the same reference characters, and their descriptions shall not be repeated. In the drawings, some configurations can be omitted or simplified for the sake of simplicity of description.

In the embodiments, an X-axis, a Y-axis, and a Z-axis of an XYZ Cartesian coordinate system respectively indicate a longitudinal direction X, a width direction Y, and a height direction Z.

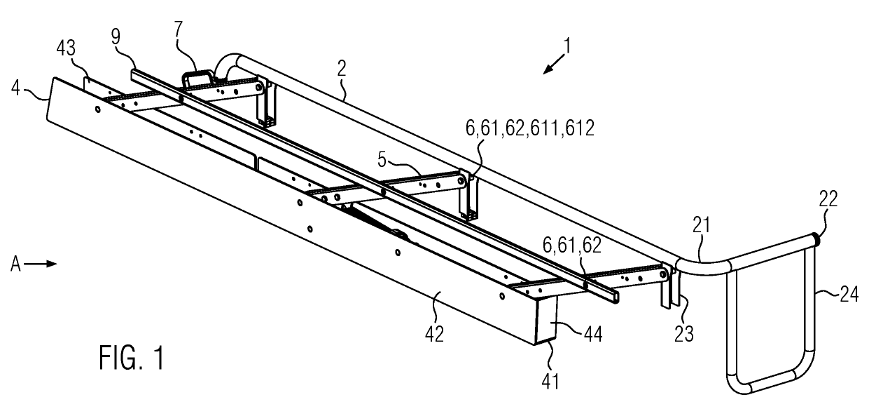

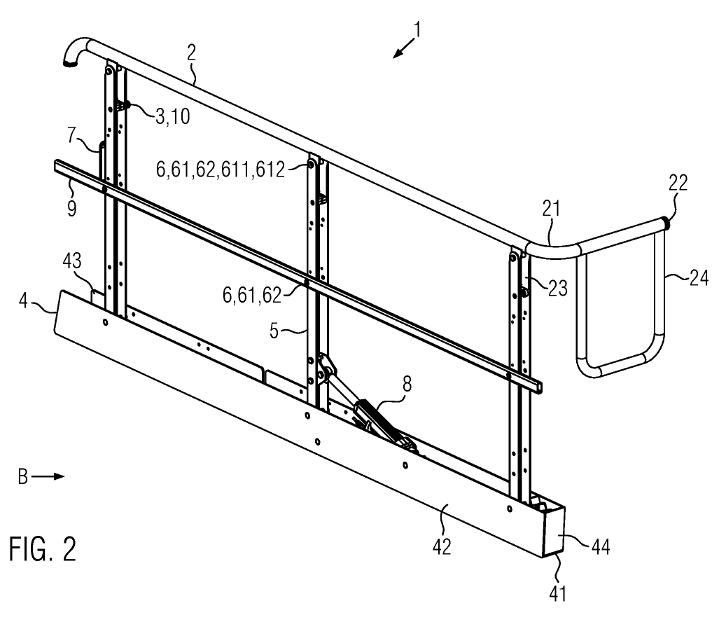

FIG. 1 shows a perspective view of a fall protection device 1 according to a first embodiment of the present disclosure in a transport position A; and FIG. 2 shows a perspective view of the fall protection device 1 according to the first embodiment of the present disclosure in a working position B. Fall protection device 1 is configured as a railing that is attached to a construction machine, e.g., a road construction machine such as a paving machine or a feeder vehicle for a paving machine. Fall protection device 1 is attached along an extension direction, i.e., the longitudinal direction, of, e.g., an operator platform or a catwalk provided on one or more sides of the construction machine to enable an operator to perform work or inspections at the construction machine.

Fall protection device 1 comprises a handrail 2 and an attachment assembly 4. Fall protection device 1 can furthermore comprise a knee rail 9.

Attachment assembly 4 comprises a base plate 41, a front side wall 42, a rear side wall 43, and two lateral side walls 44 that connect front side wall 42 and rear side wall 43 to each other to form an upwardly open box shape. A recess 45 can be formed on front side wall 42 to receive a linear actuator 8 as an aid for the manual movement between transport position A and working position B by the operator. As previously described, the present disclosure is not restricted thereto, and if the recess 45 is formed, it can also be formed in the rear side wall.

Handrail 2 is formed to be tubular with a circular, cuboid, or elliptical cross-section. An end cap 22 can be mounted on respective end sections 21 of handrail 2. As shown in FIGS. 1 and 2, one of end sections 21 in the specific embodiment is formed to be longer to allow for the attachment of a side guard 24 thereto. Furthermore, a plurality of support elements 23 is formed on handrail 2 and formed to be rod-shaped and extend from handrail 2 downwardly in the Z-axis direction.

A plurality of posts 5 is arranged at regular intervals along the longitudinal direction of fall protection device 1 to support handrail 2 and attachment assembly 4 which are arranged parallel to and spaced from one another in the height direction. Three posts 5 are shown as an example in FIGS. 1 and 2. However, depending on the dimensions of fall protection device 1, two or more than three posts 5 can be provided. Each of the plurality of posts 5 can be formed as a single post or formed as two posts spaced from one another in the Y-axis direction, i.e., as a double post. If the plurality of posts 5 is formed as individual posts, they can be formed in the shape of a piece of sheet metal bent to a C shape, as shown in FIGS. 1 and 2.

A connecting mechanism 6 shown in FIGS. 1 and 2 is configured as a pivot joint 61 at connection points 62, the pivot joint being actuated to provide a parallelogram guide. Connection point 62 is the joining point between each of posts 5 and handrail 2 and between each of posts 5 and attachment assembly 4. Joint 61 consists of a bore 611 formed in each of posts 5 and a bolt 612 that forms a connection member between the individual post or double post. Bolt 612 is mounted to be rotatable in bore 611.

Fall protection device 1 further comprises a handle 7 which is attached to the side of one of the plurality of posts 5 or to the inner side thereof, as shown in FIGS. 1 and 2. The operator grasps the handle and moves the fall protection device by pulling it in the direction of the working position and by pushing it in the direction of the transport position.

In transport position A, as shown in FIG. 1, fall protection device 1 rests on one of lateral side walls 44 and is held in this position by its own weight. In transport position A, fall protection device 1 has the shape of a parallelogram. In working position B, as shown in FIG. 2, fall protection device 1 is in an upright position and has the shape of a rectangle. This means that fall protection device 1 can be moved between transport position A and working position B by unfolding and folding the plurality of posts 5 in a plane defined by the X-axis direction and the Z-axis direction. This ensures quick setup and safe assembly and disassembly of fall protection device 1. In working position B, holding elements 23 shown in FIG. 2 serve as stabilizing elements and as a stop in the case of posts 5 bent to a C shape. During the movement between transport position A and working position B, holding elements 23 serve as guide aids.

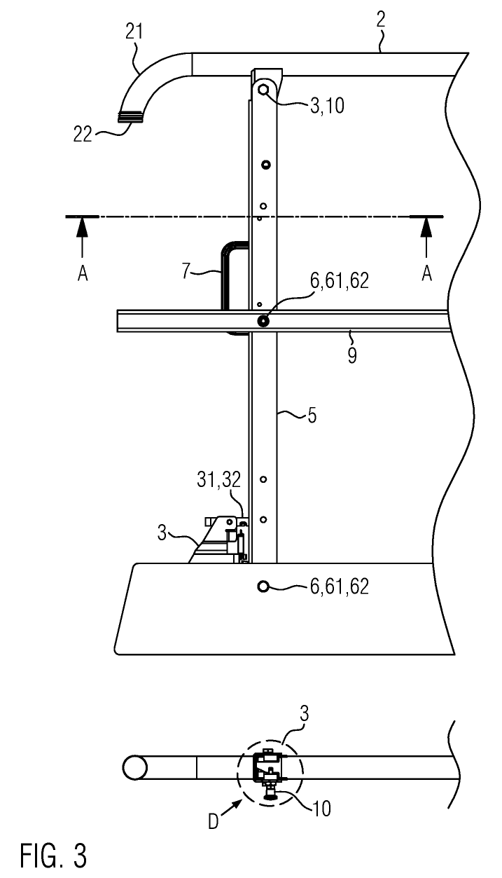

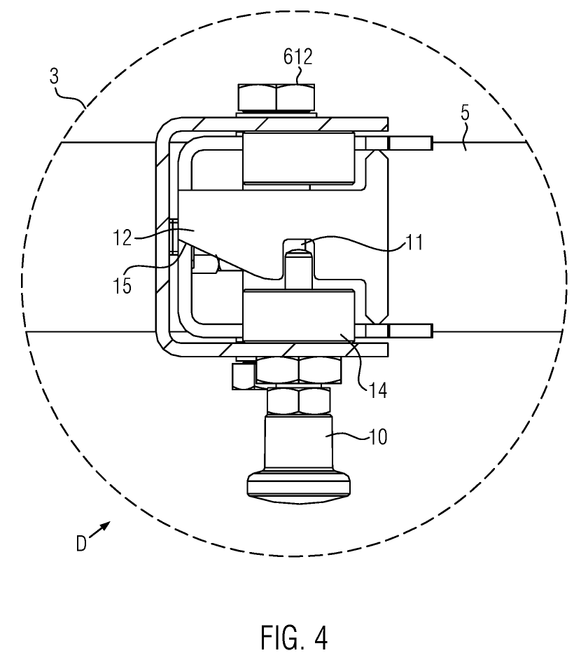

A locking element 3 is provided on fall protection device 1 for securely locking fall protection device 1 in working position B. In the example shown in FIG. 3, locking element 3 is a latching element in the form of a latching tab 31 formed on attachment assembly 4 and a latching element 32 provided in the form of a rod-shaped element or a recess is provided on one of posts 5 so that latching tab 31 can engage with latching element 32. Latching mechanism formed by locking element 3 can be implemented by way of a return spring or by manual locking. Alternatively, locking element 3 is a latching bolt 10, as shown in section D in FIG. 3 and FIG. 4.

FIG. 4 shows an enlarged view of section D of FIG. 3 illustrating a locking element 3 according to a modification of the first embodiment of the present disclosure. In this case, locking element 3 is formed as latching element by a latching pin 10 and a recess 11 that is formed in a guide element 12 and into which latching pin 10 engages. To facilitate the guidance of latching pin 10 into recess 11, guide element 12 has a conical guide surface 15 along which latching pin 10 slides. Locking element 3 is attached to one of the plurality of posts 5 by way of bolts 612. A return spring 14 is formed in latching pin 10, the return force of which enables latching and unlatching. The latching and unlatching of latching pin 10 can be achieved by the operator manually moving latching pin 10.

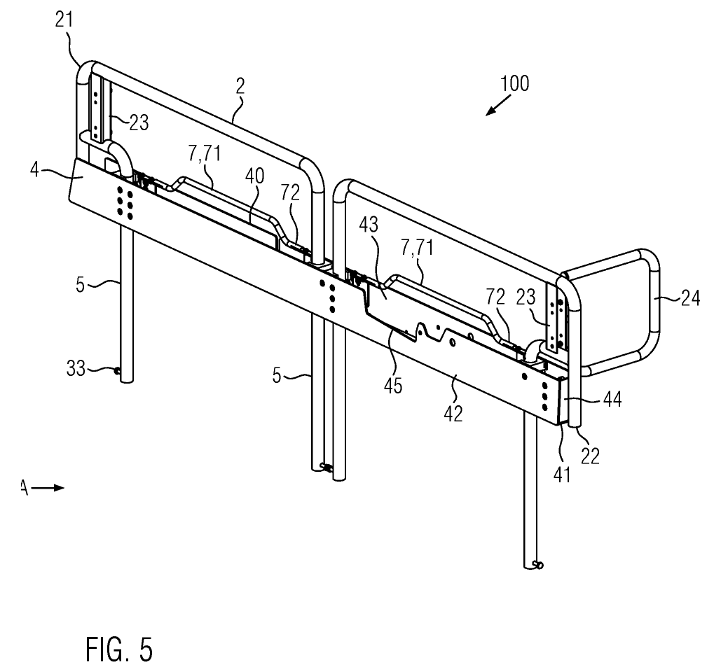

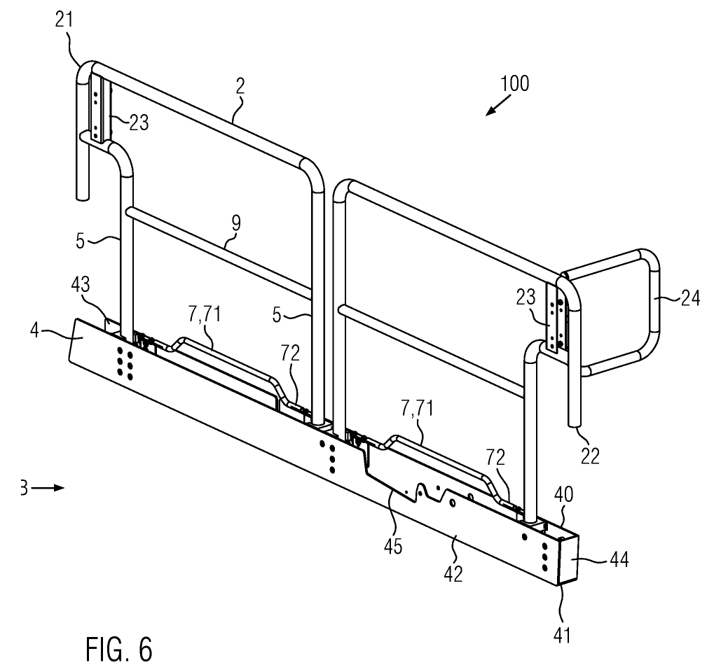

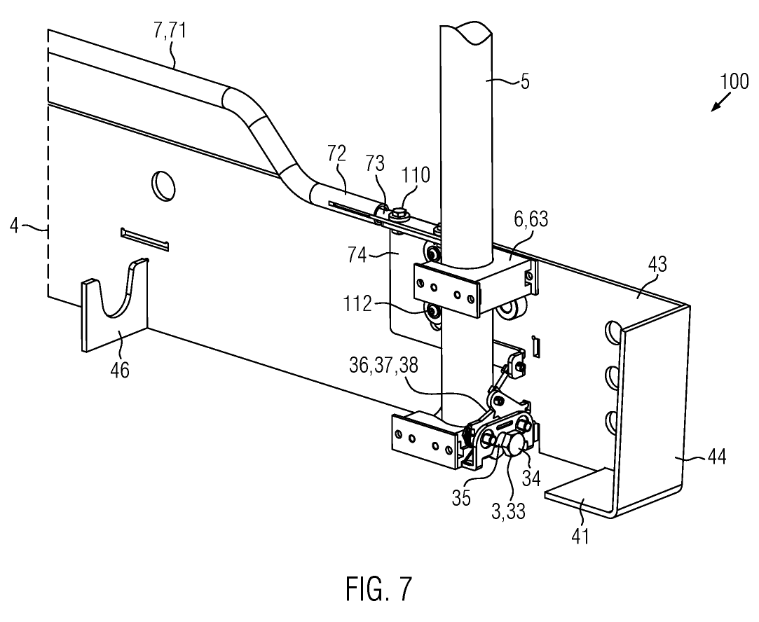

FIG. 5 shows a perspective view of a fall protection device 100 according to a second embodiment of the present disclosure in transport position A and FIG. 6 shows a perspective view of a fall protection device according to the second embodiment of the present disclosure in a working position. FIG. 7 shows a detailed view of a connecting mechanism and a locking element according to the second embodiment of the present disclosure. In FIGS. 5 to 7, the components corresponding to those of the first embodiment are designated by the same reference characters and their description will not be repeated.

Fall protection device 100 shown in FIGS. 5 and 6 comprises two posts 5 with a round cross-section which are formed integrally with handrail 2. A knee rail 9 is also provided. More than one fall protection device 100, which can be connected to one another by attachment devices (not shown), can be provided. This modular construction has the advantage that fall protection device 100 can be used in any construction machine since its length can be individually adjusted.

The second embodiment differs from the first embodiment in that fall protection device 100 is moved by vertical guidance between transport position A and working position B. For this purpose, handrail 2 is gripped by the operator, pulled up, and automatically locked, whereby fall protection device 100 is transferred quickly and in a simple manner from transport position A to working position B. If fall protection device 1 is taken to working position B by pulling it upwardly, then the automatic lock can be achieved by a snap lock, as shown in FIG. 7, in which a latching tab 37 engages in a recess 38.

To release the lock, the operator pulls on handle 7 with their hand or foot. This releases the engagement between latching tab 37 and recess 38 of snap lock 36.

Handle 7 is configured in the form of a trapezoidal rod 71, end sections 72 of which are bent outwardly such that they can be attached to a top side 40 of attachment assembly 4, as shown in FIGS. 5 to 7. In the embodiment, handle 7 is located on rear side wall 43. Provided at each end section 72 is a plate-shaped attachment member 73 which is welded or connected in a frictional fit to handle 7. Plate-shaped attachment member 73 comprises two passage holes. An attachment plate 74 is attached to the inner surface of rear side wall 43. Attachment plate 74 is formed to be L-shaped and is attached to rear side wall 43 such that the short leg of the L-shape is disposed at the height of top side 40 and protrudes inwardly (in the direction of front side wall 42) to serve as a support surface. The long leg of the L-shape is attached to the inner surface of the rear side wall using screws 112. The short leg of the L-shape has two passage holes. In the present embodiment, two respective passage holes each are formed. Plate-shaped attachment member 73 is screwed to attachment plate 74 using screws 110.

Connecting mechanism 6 according to the second embodiment is a guide 63 which is configured in the form of two cylindrical elements with a cuboid cross-section. Posts 5 are guided in guide 63 such that they can be moved with the aid of handrail 2 from transport position A, as shown in FIG. 5, to working position B, as shown in FIG. 6. This is done by vertically pulling railing up with handrail 2. In working position B, fall protection device 100 is automatically locked by way of locking element 3. In the present example, knee rail 9 serves as a stop for limiting the movement from working position B to transport position A. On the inner surface of base plate 41 of attachment assembly 4, a support 46 is formed, which is configured to be U-shaped to receive knee rail 9. The shape of support 46 corresponds to the cross-sectional shape of knee rail 9. Fall protection device 100 is moved from working position B to transport position A in that the operator grasps the railing, unlocks it using handle 7, and then lowers it downwardly.

Locking element 3 according to the second embodiment is a screw-shaped element 33 that interacts with guide 63 to lock fall protection device 100 in working position B, as shown in FIG. 7. Screw-shaped element 33 comprises a screw head 34 and a shaft 35.

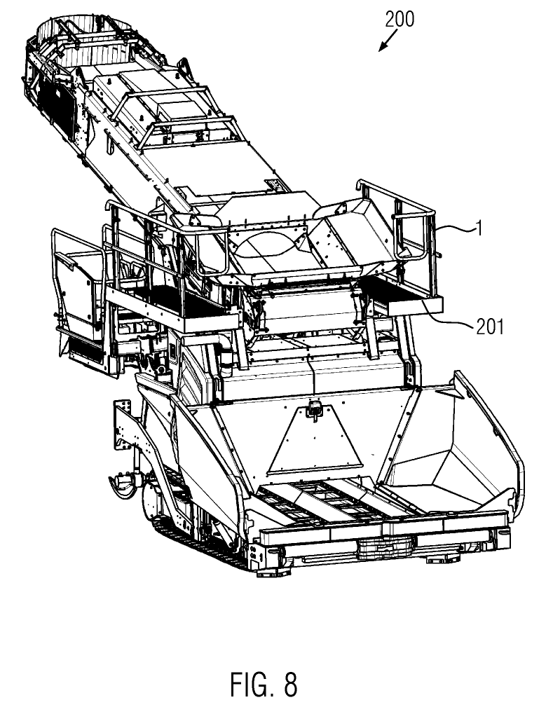

FIG. 8 shows a construction machine 200, in particular a feeder vehicle, which can optionally be used as a paving machine by attaching a screed to the flanges of the drawbars, with a catwalk 201 and fall protection device 1. It goes without saying that construction machine 200 can also comprise fall protection device 100 according to the second embodiment. Fall protection device 1, 100 can also be attached to an operator station in addition to or instead of being attached to catwalk 201.

It should be understood that the embodiment presently disclosed is illustrative in all respects and is not restrictive. The scope of the present disclosure is defined by the terms of the claims and not by the above description and is intended to comprise all modifications within the scope and meaning that correspond to the terms of the claims.

### Reference sign list

1,100 fall protection device (railing)

2 Handrail

10 latching bolt

11 recess

12 guide element

14 return spring

15 conical guide surface

21 end section

22 end cap

23 support elements

24 side protection

3 locking element

31 latching element

32 counterpart (latching element)

33 screw-shaped element

34 screw head 35 shank

36 latching element

37 latching tab

38 recess

4 attachment assembly

40 top side

41 base plate

42 front side wall

43 rear side wall

44 lateral side wall

45 recess

46 support

5 post

6 connecting mechanism

61 pivot joint

611 bore

612 bolt

62 connection point

63 guide

7 handle

71 trapezoidal rod

72 end section

73 plate-shaped attachment element

74 l-shaped attachment plate

8 linear actuator

9 knee rail 110 screw

112 screw

200 construction machine

201 catwalk

A transport position

B working position

What is claimed is:

1. A fall protection device for a construction machine, the fall protection device comprising:
a handrail;
an attachment assembly;
a plurality of posts arranged at intervals along an X-axis of a Cartesian XYZ coordinate system of the fall protection device and configured to support the handrail and the attachment assembly which are arranged parallel and spaced from one another along a Z-axis of the Cartesian XYZ coordinate system; and
a connecting mechanism for connecting the plurality of posts to the handrail and the attachment assembly such that the fall protection device is movable in a plane formed by the X-axis and the Z-axis between a transport position and a working position.

2. The fall protection device for a construction machine according to claim 1, furthermore comprising:
a handle for manually moving the fall protection device between the transport position and the working position.

3. The fall protection device for a construction machine according to claim 1, wherein the working position is adjustable by a locking element.

4. The fall protection device for a construction machine according to claim 3, wherein the locking element is formed on the attachment assembly or on one of the posts.

5. The fall protection device for a construction machine according to claim 1, furthermore comprising:
a linear actuator for supporting movement between the transport position and the working position.

6. The fall protection device for a construction machine according to claim 5, wherein the linear actuator is provided on the attachment assembly.

7. The fall protection device for a construction machine according to claim 5, wherein the linear actuator is received in a recess formed in or on the attachment assembly.

8. The fall protection device for a construction machine according to claim 1, wherein the connecting mechanism comprises a pivot joint at connection points of the plurality of posts to provide a parallelogram guide for movement of the fall protection device between the transport position and the working position.

9. The fall protection device for a construction machine according to claim 2, wherein the handle is provided on one of the plurality of posts.

10. The fall protection device for a construction machine according to claim 3, wherein the locking element comprises a latching element and a counterpart formed on one of the plurality of posts, wherein the latching element and the counterpart are engageable with each other.

11. The fall protection device for a construction machine according to claim 1, wherein the fall protection device is supported in the transport position by its own weight.

12. The fall protection device for a construction machine according to claim 1, wherein the connecting mechanism comprises a guide formed on the attachment assembly and configured to guide vertical movement of the fall protection device between the transport position and the working position.

13. The fall protection device for a construction machine according to claim 2, wherein the handle is provided on the attachment assembly.

14. The fall protection device for a construction machine according to claim 10, wherein the latching element comprises a snap lock that interacts with the connecting mechanism to lock the fall protection device in the working position.

15. A construction machine comprising the fall protection device according to claim 1.

16. A fall protection device for a construction machine, the fall protection device comprising:
a handrail;
an attachment assembly;
a plurality of posts arranged at intervals along an X-axis of a Cartesian XYZ coordinate system of the fall protection device and attached to the handrail and the attachment assembly, wherein the handrail and the attachment assembly are arranged parallel to and spaced from each other along a Z-axis of the Cartesian XYZ coordinate system; and
a connecting mechanism for connecting the plurality of posts to the handrail and the attachment assembly such that the handrail is movable in a plane formed by the X-axis and the Z-axis between a transport position and a working position.
